(19) United States
(12) Patent Application Publication
(10) Pub. No.: US 2025/0255411 A1
(43) Pub. Date: Aug. 14, 2025

(54) ADJUSTABLE BACKREST

(71) Applicant: High Tech Health International, Inc., Lafayette, CO (US)

(72) Inventor: Erik Johnson, Boulder, CO (US)

(21) Appl. No.: 19/045,356

(22) Filed: Feb. 4, 2025

Related U.S. Application Data
(60) Provisional application No. 63/552,621, filed on Feb. 12, 2024.

(51) Int. Cl. A47C 1/032; A47C 7/40

(52) U.S. Cl. CPC A47C 1/032; A47C 7/402

(57) ABSTRACT

Embodiments of the present disclosure include an adjustable backrest. Embodiments include a seat and a backrest. The backrest is adjustable and supported by pins that engage a plurality of holes arranged vertically to set a height of the backrest and a plurality of grooves arranged horizontally to set an angle of the backrest relative to the seat. The adjustable backrest is particularly advantageous for use in a sauna.

### CROSS REFERENCE TO RELATED APPLICATIONS

This application claims the benefit of priority to U.S. Provisional Patent Application No. 63/552,621, filed Feb. 12, 2024, the contents of which are hereby incorporated herein by reference.

### BACKGROUND

The present disclosure relates generally to a backrest, and in particular, to an adjustable backrest that may be used in a sauna, for example.

A backrest is a portion of a seat providing support for a person's back and upper torso. It is often desirable to change the height and/or angle of the backrest relative to the seat to allow a person to be more or less in a reclining position.

A sauna, or sudatory, is a small room or building designed as a place to experience dry or wet heat sessions. Purported advantages of using a sauna include stress and tension reduction, weight loss, toxin removal, and increased beneficial circulation, for example.

Typically, saunas are found at spas and similar commercial establishments, but more consumers are purchasing home saunas for their individual private use. Traditionally, saunas include fixed seating on a bench or chair. However, some people find it challenging to find a comfortable position to adequately enjoy a sauna session. Others prefer to change their body position during a sauna session to provide stabilizing support, fatigue reduction, and comfort while promoting a healthy posture, for example.

Features, aspects, and advantages of various embodiments of the disclosure will become better understood with regard to the following description, appended claims, accompanying drawings and abstract.

### BRIEF DESCRIPTION OF THE DRAWINGS

FIG. 1A illustrates a side view of an adjustable backrest according to an embodiment.

FIG. 1B illustrates another view of an adjustable backrest according to an embodiment.

FIG. 1C illustrates a sauna according to an embodiment.

FIG. 2 illustrates backrest adjustments according to an embodiment.

FIG. 3A illustrates a perspective view of a backrest adjusted at a maximum height and smallest angle relative to a seat according to an embodiment.

FIG. 3B illustrates a perspective view of a backrest adjusted at a maximum height and largest angle relative to a seat according to an embodiment.

FIG. 3C illustrates a perspective view of a backrest adjusted at a lowest height and smallest angle relative to a seat according to an embodiment.

FIG. 3D illustrates a perspective view of a backrest adjusted at a lowest height and largest angle relative to a seat according to an embodiment.

FIG. 4 illustrates a perspective view of a backrest positioned along a wall of a sauna according to an embodiment.

### DETAILED DESCRIPTION

Described herein are adjustable backrests. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

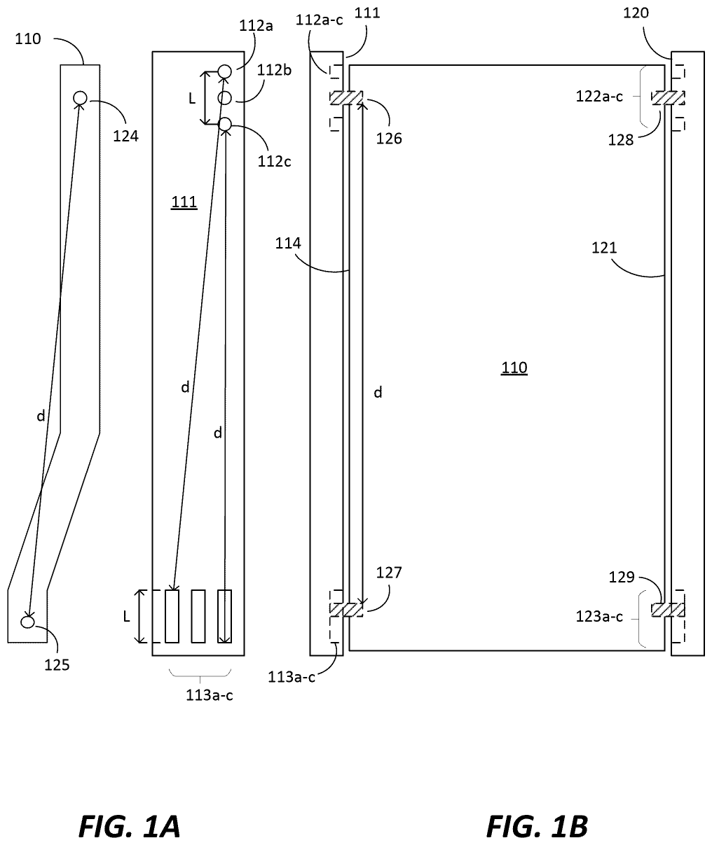

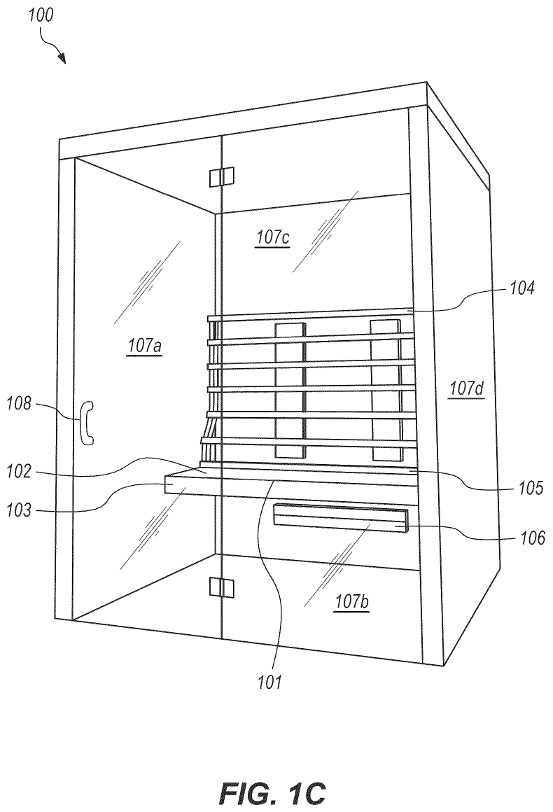

FIG. 1A illustrates a side view of an adjustable backrest 110 according to an embodiment. Embodiments of the present disclosure include an apparatus including an adjustable backrest. Adjustable backrest 110 may be supported by at least one surface 111 configured proximate to a side 114 of the backrest 110 to support the backrest. FIG. 1A includes both side views of the backrest 110 and surface 111. In this example, surface 111 includes a plurality of first holes 112a-c configured above a plurality of first grooves 113a-c. In this embodiment, holes 112a-c are configured at different heights (e.g., vertically) and grooves 113a-c are configured at different horizontal positions (e.g., horizontally in parallel). Holes 112a-c may be used to set a height of the backrest and grooves 113a-c may be used to set an angle of the backrest relative to a seat (shown below). Holes 112a-c and grooves 113a-c are one example means for adjustably mounting backrest 110. In some embodiments, the number of holes 112a-c may be equal to the number of grooves 113a-c, although in other embodiments different numbers of holes and grooves may be used.

FIG. 1B illustrates another view of an adjustable backrest according to an embodiment. FIG. 1B illustrates that surface 111 may be configured proximate to the side 114 to support the backrest 110. In this example, backrest is supported by a second surface 120 proximate to a second side 121 of the backrest, the second side being opposite side 114. Either of the surfaces 111 and 120 may be a wall, such as a wall of a sauna or other structure, for example. Similar to surface 111, surface 120 includes a plurality of holes 122a-c configured at different heights and a plurality of grooves 123a-c configured at different horizontal positions.

In this example, side 114 of backrest 110 includes hole 124 and hole 125. A pin 126 may be used to engage hole 124 and one of the holes 112a-c to set a height of the backrest. Similarly, another pin 127 may be used to engage hole 125 and one of the grooves 113a-c to set an angle between a seat and the backrest. In this example, side 121 includes similar holes, and pins 128 and 129 are used engage holes 122a-c and grooves 123a-c, for example. Pins are one example means for engaging the adjustable mounting coupled between the side 114 and surface 111 and/or the side 121 and surface 120.

FIG. 1A also illustrates some example dimensional relations between the holes and grooves according to some embodiments. In this example, a distance between the top hole 124 is a distance, d, from the bottom hole 125. Accordingly, as hole 124 engages with different holes 112a-c to set the height, bottom hole 125 moves vertically. The vertical movement is also impacted by the engagement of bottle hole 125 with different grooves. Advantageously, in this example, the distance, d, between hole 124 and hole 125 is greater than a distance between a uppermost hole 112a and an uppermost end of a forwardmost groove 113a of grooves 113a-c. This ensures pin 127 can engage both hole 125 and the forwardmost groove 113a when pin 126 engages the uppermost hole 112a. Similarly, the distance, d, between hole 124 and hole 125 is less than a second distance between a lowermost hole 112c and a lowermost end of a rearmost groove 113c. This ensures pin 127 can engage both hole 125 and the rearmost groove 113c when pin 126 engages the lowermost hole 112c. Similarly, in some embodiments, a length, L, of each the plurality of first grooves is greater than a distance between an uppermost hole and lowermost hole of the plurality of first holes.

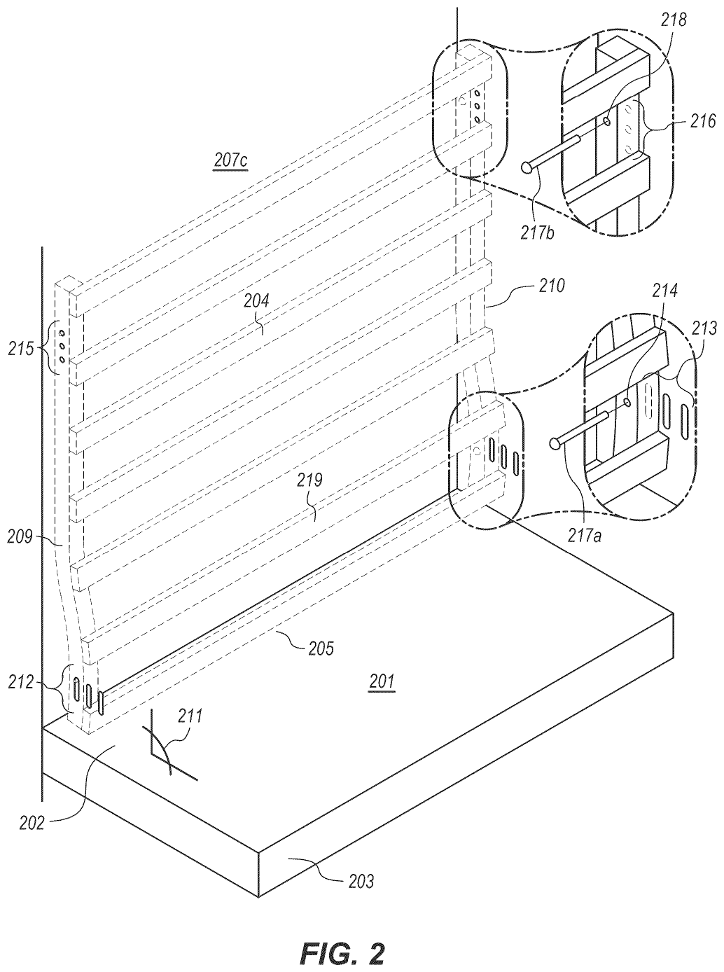

Features and advantages of the present disclosure are particularly innovative and advantageous for use in a sauna, such as a home sauna, for example. FIG. 1C illustrates a sauna according to an embodiment. As depicted in FIG. 1C, a sauna 100 comprises a seat 101 with a proximate side 103 and a top 102 configured horizontally. The sauna 100 also comprises a backrest 104. As shown in FIG. 2, the backrest 204 (104 in FIG. 1C) comprises a first side 209, a second side 210, and a bottom side 205 adjacent to the seat 201 (101 in FIG. 1C). The backrest 204 is configured at an angle 211 to the seat 201 and between a first mount adjacent to the first side 209 and a second mount adjacent to the second side 210. In FIG. 1C, the first and second mounts are interior walls 107a-d of the sauna, for example. The angle 211 can be adjusted. The first mount comprises a plurality of first holes 215 (e.g., in a surface of a wall adjacent to the backrest 104) configured vertically, the plurality of first holes 215 configured above a plurality of first vertical grooves 212 (e.g., also in a surface of the wall) configured in parallel. Similarly, the second mount comprises a plurality of second holes 216 configured vertically, the plurality of second holes 216 configured above a plurality of second vertical grooves 213 configured in parallel. The first side 209 is configured to engage one of the plurality of first holes 215 and the second side 210 is configured to engage one of the plurality of second holes 216 to set a height of the backrest 204. The first side 209 is configured to engage one of the plurality first vertical grooves 212 and the second side 210 is configured to engage one of the plurality of second vertical grooves 213 to set the angle 211 between the seat 201 and the backrest 204. Per FIG. 1C, the first mount may be a first wall 107a of the sauna 100 and the second mount may be a second wall 107d of the sauna 100, for example. Of course, the first and second mounts may also be in other locations with the backrest 204 positioned between the first and second mounts. The number of the plurality of first holes 215 may be equal to a number of the plurality of second holes 216 and the number of the plurality of first vertical grooves 212 may be equal to a number of the plurality of second vertical grooves 213. For example, FIG. 2 shows a total of three second holes 216 and three vertical grooves 213. Of course, this number may vary to provide more or less configurations in which the backrest 204 may be optionally adjusted.

The first side 209 comprises a first hole proximate on an upper portion of the first side and the second side 210 comprises a second hole 218 proximate to an upper portion of the second side 210. In this example, the sauna further comprises a first dowel pin extending through the first hole in the first side 209 to one of the plurality of first holes 215 in the first mount and a second dowel pin 217b extending through the second hole 218 in the second side 210 to one of the plurality of second holes 216 in the second mount. Due to the perspective of FIG. 2, the first and second holes and dowel pins in the first side 209 are not visible; however, the first side 209 is similar to the configuration shown in the magnified views of the second side 210. The first side 209 comprises a second hole proximate on a lower portion of the first side 209 and the second side comprises a second hole proximate to a lower portion of the second side 210. The sauna further comprises a dowel pin extending through the second hole in the first side 209 to one of the plurality of first vertical grooves 212 in the first mount and a second dowel pin 217a extending through the second hole 214 in the second side 210 to one of the plurality of second vertical grooves 213 in the second mount. The first dowel pin 217a and the second dowel pin 217b may be slip-fitted wooden dowel pins, for example. Other pins commonly known to those of skill in the art may also be utilized in a similar manner.

The first side 209 of the backrest 204 is parallel to the first mount along a first surface, the second side 210 is parallel to the second mount along a second surface. The first side 209 and second side 210 are curved along corresponding third surface 219. The corresponding third surface 219 is configured to engage a lower region of a spinal column (e.g., lumbar spine) of a sauna user. Thus, adjusting the height and angle of the backrest may advantageously provide more optimum lumbar support for different users. In this example, the backrest 204 further comprises a plurality of wooden slats configured between the first side 209 and the second side 210 of the backrest 204. The walls, sides, and seat may also be made of wood according to some embodiments.

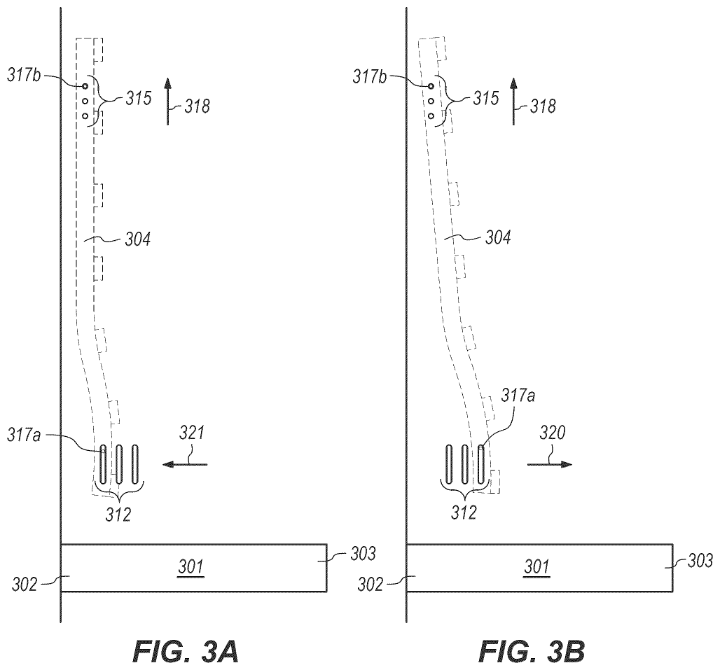

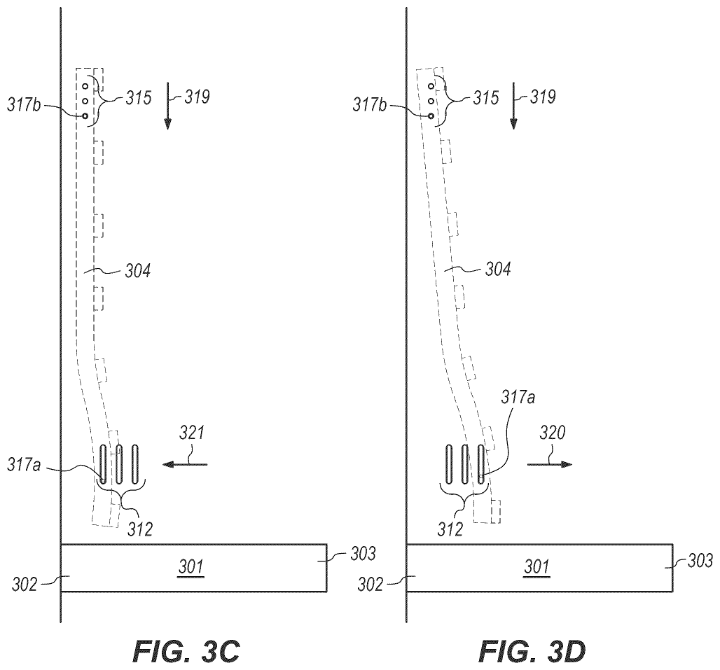

As shown in FIG. 3A, a backrest may comprise a hole 317b in a side of the backrest for engaging one of the plurality of first holes 315 in a supporting surface and a hole 317a on the same side of the backrest for engaging one of the plurality first vertical grooves 312 in the supporting surface. In a similar fashion, the opposite side of the backrest comprises a hole for engaging one of the plurality of holes in the opposite surface and a hole for engaging one of the plurality of second vertical grooves in the opposite surface. FIG. 3A illustrates a side view of a backrest 304 at a maximum height 318 and smallest angle 321 relative to a seat 301 according to an embodiment. Note the position of the first side hole 317b engages the highest hole of the plurality of holes 315 and the hole 317a engages a rearmost groove (relative to the seat) of the plurality of vertical grooves 312 to adjust the backrest 304 at a maximum height 318 and smallest angle 321 relative to the seat 301. In this example configuration, the backrest is in more of an upright position forming an angle closer to about 90° relative to the seat.

Turning now to FIG. 3B, the first side comprises a hole 317b (e.g., on the backrest) for engaging one of the plurality of first holes 315 and a hole 317a for engaging one of the plurality first vertical grooves 312. In a similar fashion, the second side comprises a hole for engaging one of the plurality of second holes and a hole for engaging one of the plurality of second vertical grooves. FIG. 3B illustrates a side view of a backrest 304 at a maximum height 318 and largest angle 321 relative to a seat 301 according to an embodiment. Note the position of the first side hole 317b engages the highest hole of the plurality of holes 315 and the hole 317a engages the forwardmost groove (relative to the seat) of the plurality of vertical grooves 312 to adjust the backrest 304 at a maximum height 318 and largest angle 320 relative to the seat 301 according to an embodiment. In this configuration, the backrest is reclined back at an inclination generally more than about 90° relative to the seat.

Per FIG. 3C, the first side comprises hole 317b for engaging one of the plurality of first holes 315 and hole 317a for engaging one of the plurality first vertical grooves 312. In a similar fashion, the second side comprises a hole for engaging one of the plurality of second holes and a hole for engaging one of the plurality of second vertical grooves. FIG. 3C illustrates a side view of a backrest 304 at a minimum height 319 and smallest angle 321 relative to a seat 301 according to an embodiment. Note the position of the first side hole 317b engages the lowest hole of the plurality of holes 315 and the hole 317a engages the rearmost groove (relative to the seat) of the plurality of vertical grooves 312 to adjust the backrest 304 at minimum height 319 and smallest angle 321 relative to the seat 301. In this configuration, the backrest is in more of an upright position forming an angle closer to about 90° relative to the seat with the lumbar support being lower toward the seat.

As shown in FIG. 3D, the first side comprises hole 317b for engaging one of the plurality of first holes 315 and hole 317a for engaging one of the plurality first vertical grooves 312. In a similar fashion, the second side comprises hole for engaging one of the plurality of second holes and hole for engaging one of the plurality of second vertical grooves. FIG. 3D illustrates a side view of a backrest 304 at a minimum height 319 and largest angle 320 relative to a seat 301. Note the position of the first side hole 317b engages the lowest hole of the plurality of holes 315 and the hole 317a engages the forwardmost groove of the plurality of vertical grooves 312 to adjust the backrest 304 at minimum height 319 and largest angle 320 relative to the seat 301 according to an embodiment. In this configuration, the backrest is reclined back at an inclination generally more than about 90° relative to the seat with a lower lumbar support.

As the example embodiments in FIGS. 3A-D illustrate, holes 315 set a height of the backrest while the grooves 312 set an angle of the backrest.

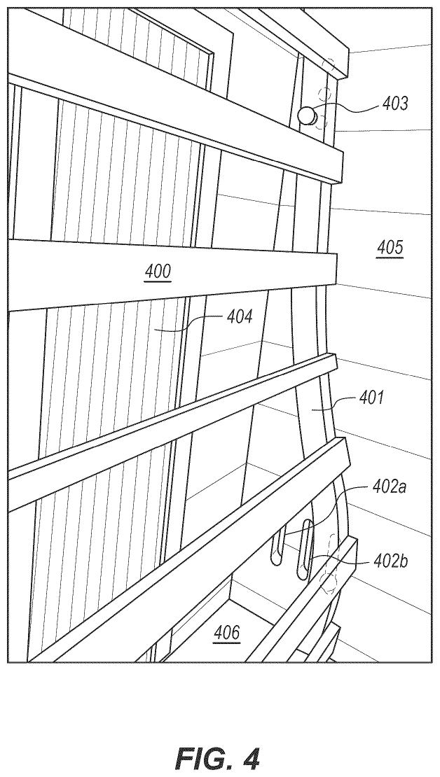

FIG. 4 illustrates a perspective view of an adjustable backrest 400 positioned along a wall 405 of a sauna according to an embodiment. In this drawing, a heating unit 404 is positioned behind the backrest 400; however, any number of heating units may be placed in a variety of locations. A dowel pin 403 engages through a side of the backrest into one of a plurality of holes arranged vertically to adjust the height of the backrest 400. Note that another lower dowel pin is obscured and shown in dashed lines behind backrest 400. The lower dowel pin engages one of a plurality of grooves 402a, 402b (partially obscured by backrest 400). The position of the backrest 400 in FIG. 4 is similar to the configuration shown as a side view in FIG. 3D in that dowel pin 403 engages the lowest hole of the plurality of holes (arranged vertically) and the lower dowel pin engages the furthest groove of the plurality of vertical grooves toward a front of the seat 406 to adjust the backrest 400 at minimum height and largest angle (most reclined) relative to the seat 406 according to an embodiment. Alternatively, if the plurality of grooves and the plurality of holes each equaled three holes and grooves and the first and second dowel pins engaged the middle hole and the middle groove, the backrest would be adjusted at an intermediate height and an intermediate angle of reclination relative to the seat.

### FURTHER EXAMPLES

The following paragraphs contain non-limiting example combinations of various embodiments.

In one embodiment, the present disclosure includes an apparatus comprising: a seat comprising a surface configured horizontally; a backrest comprising a side and a bottom side adjacent to the seat, wherein the backrest is configured at an angle to the seat; and at least one surface configured proximate to the side to support the backrest, wherein the at least one surface comprises a plurality of first holes configured at different heights, the plurality of first holes configured above a plurality of first grooves configured at different horizontal positions, wherein the side comprises a second hole and a third hole, wherein a first pin engages the second hole and one of the plurality of first holes to set a height of the backrest, and wherein a second pin engages the third hole and one of the plurality of grooves to set the angle between the seat and the backrest.

In one embodiment, the apparatus is a sauna.

In one embodiment, the at least one surface is a first wall.

In one embodiment, a number of the plurality of first holes is equal to a number of the plurality of first grooves.

In one embodiment, a distance between the second hole and the third hole is greater than a first distance between a uppermost hole of the first plurality of first holes and an uppermost end of a forwardmost groove of the plurality of first grooves, and wherein the distance between the second hole and the third hole is less than a second distance between a lowermost hole of the plurality of first holes and an lowermost end of a rearmost groove of the plurality of first grooves.

In one embodiment, a length of each the plurality of first grooves is greater than a distance between an uppermost hole and lowermost hole of the plurality of first holes.

In one embodiment, the at least one surface is a first surface configured proximate to the first side and a second surface configured proximate to a second side the second side of the backrest to support the backrest.

In one embodiment, the plurality of first holes are configured vertically and the plurality of first grooves are vertical grooves configured in parallel.

In one embodiment, the present disclosure includes a sauna comprising: a seat configured horizontally; a backrest comprising a first side, a second side, and a bottom side adjacent to the seat, wherein the backrest is configured at an angle to the seat and between a first mount adjacent to the first side and a second mount adjacent to the second side, wherein the first mount comprises a plurality of first holes configured vertically, the plurality of first holes configured above a plurality of first vertical grooves configured in parallel, and the second mount comprises a plurality of second holes configured vertically, the plurality of second holes configured above a plurality of second vertical grooves configured in parallel; wherein the first side is configured to engage one of the plurality of first holes and the second side is configured to engage one of the plurality of second holes to set a height of the backrest, and wherein the first side is configured to engage one of the plurality first vertical grooves and the second side is configured to engage one of the plurality of second vertical grooves to set the angle between the seat and the backrest.

In one embodiment, the first mount is a first wall of the sauna and wherein the second mount is a second wall of the sauna.

In one embodiment, a number of the plurality of first holes is equal to a number of the plurality of second holes, and wherein a number of the plurality of first vertical grooves is equal to a number of the plurality of second vertical grooves.

In one embodiment, the first side comprises a first hole proximate on an upper portion of the first side and the second side comprises a second hole proximate to an upper portion of the second side, the sauna further comprising: a first dowel pin extending through the first hole in the first side to one of the plurality of first holes in the first mount; and a second dowel pin extending through the second hole in the second side to one of the plurality of second holes in the second mount.

In one embodiment, the first side comprises a first hole proximate on a lower portion of the first side and the second side comprises a second hole proximate to a lower portion of the second side, the sauna further comprising: a first dowel pin extending through the first hole in the first side to one of the plurality of first vertical grooves in the first mount; and a second dowel pin extending through the second hole in the second side to one of the plurality of second vertical grooves in the second mount.

In one embodiment, the first dowel pin and the second dowel pin are wooden dowel pins.

In one embodiment, the first side is parallel to the first mount along a first surface, the second side is parallel to the second mount along a second surface, and the first side and second side are coupled together to form a curved third surface.

In one embodiment, the third surface is configured to engage a lower region of a spinal column of a user.

In one embodiment, further comprising a plurality of wooden slats configured between the first side and the second side.

In one embodiment, the present disclosure includes a sauna comprising: a seat configured horizontally; a backrest comprising a first side, a second side, and a bottom side adjacent to the seat, wherein the backrest is configured at an angle to the seat and supported by one or more adjustable mounting means for setting a height and angle configured on one or more walls of the sauna and adjacent to one or more of the first side and the second side; and means for engaging the adjustable mounting means coupled between at least one of the first side and a first surface or the second side and a second surface.

In one embodiment, the adjustable mounting means comprises a plurality of holes set a height of the backrest and a plurality of grooves set an angle of the backrest.

In one embodiment, the means for engaging comprises a plurality of dowel pins for engaging the plurality of holes and the plurality of grooves.

In one embodiment, the seat, the backrest, the one or more walls, the adjustable mounting means, and the means for engaging are wood, the sauna further comprising a plurality of wooden slats configured between the first side and the second side.

In another embodiment the present disclosure includes a sauna comprising: a seat comprising configured horizontally; a backrest comprising a first side, a second side, and a bottom side adjacent to the seat, wherein the backrest is configured at an angle to the seat and between a first mount adjacent to the first side and a second mount adjacent to the second side, wherein the first mount comprises a plurality of first holes configured vertically, the plurality of first holes configured above a plurality of first vertical grooves configured in parallel, and the second mount comprises a plurality of second holes configured vertically, the plurality of second holes configured above a plurality of second vertical grooves configured in parallel; wherein the first side is configured to engage one of the plurality of first holes and the second side is configured to engage one of the plurality of second holes to set a height of the backrest, and wherein the first side is configured to engage one of the plurality first vertical grooves and the second side is configured to engage one of the plurality of second vertical grooves to set the angle between the seat and the backrest.

In one embodiment, the first mount is a first wall of the sauna and wherein the second mount is a second wall of the sauna.

In one embodiment, a number of the plurality of first holes is equal to a number of the plurality of second holes, and wherein a number of the plurality of first vertical grooves is equal to a number of the plurality of second vertical grooves.

In one embodiment, the first side comprises a first hole proximate on an upper portion of the first side and the second side comprises a second hole proximate to an upper portion of the second side, the sauna further comprising: a first dowel pin extending through the first hole in the first side to one of the plurality of first holes in the first mount; and a second dowel pin extending through the second hole in the second side to one of the plurality of second holes in the second mount.

In one embodiment, the first side comprises a first hole proximate on a lower portion of the first side and the second side comprises a second hole proximate to a lower portion of the second side, the sauna further comprising: a first dowel pin extending through the first hole in the first side to one of the plurality of first vertical grooves in the first mount; and a second dowel pin extending through the second hole in the second side to one of the plurality of second vertical grooves in the second mount.

In one embodiment, the first dowel pin and the second dowel pin are wooden dowel pins.

In one embodiment, first side is parallel to the first mount along a first surface, the second side is parallel to the second mount along a second surface, and the first side and second side are coupled together to form a curved third surface.

In one embodiment, third surface is configured to engage a lower region of a spinal column of a user.

In one embodiment, the sauna further comprising a plurality of wooden slats configured between the first side and the second side.

In another embodiment, the present disclosure includes a sauna comprising: a seat comprising configured horizontally; a backrest comprising a first side, a second side, and a bottom side adjacent to the seat, wherein the backrest is configured at an angle to the seat and supported by one or more adjustable mounting means configured on one or more walls of the sauna and adjacent to one or more of the first side and the second side; wherein the first side comprises means for engaging adjustable mounting means and means for engaging one of the plurality first vertical grooves and the second side comprises means for engaging one of the plurality of second holes and means for engaging one of the plurality of second vertical grooves.

In one embodiment, the adjustable mounting means comprises a plurality of holes set a height of the backrest and a plurality of grooves set an angle of the backrest.

In one embodiment, the means for engaging comprises a plurality of pins for engaging the plurality of holes and the plurality of grooves.

In one embodiment, the seat, the backrest, the one or more walls, the adjustable mounting means, and the means for engaging are wood, the sauna further comprising a plurality of wooden slats configured between the first side and the second side.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

Although embodiments of the disclosure have been described in considerable detail with reference to certain preferred versions thereof, other embodiments are possible. Therefore, the spirit and scope of the appended claims should not be limited to the description of the embodiments above.

What is claimed is:

1. An apparatus comprising:
a seat comprising a surface configured horizontally;
a backrest comprising a side and a bottom side adjacent to the seat, wherein the backrest is configured at an angle to the seat; and
at least one surface configured proximate to the side to support the backrest,
wherein the at least one surface comprises a plurality of first holes configured at different heights, the plurality of first holes configured above a plurality of first grooves configured at different horizontal positions,
wherein the side comprises a second hole and a third hole,
wherein a first pin engages the second hole and one of the plurality of first holes to set a height of the backrest, and wherein a second pin engages the third hole and one of the plurality of grooves to set the angle between the seat and the backrest.

2. The apparatus of claim 1, wherein the at least one surfaces is a first wall.

3. The apparatus of claim 1, wherein a number of the plurality of first holes is equal to a number of the plurality of first grooves.

4. The apparatus of claim 1, wherein a distance between the second hole and the third hole is greater than a first distance between a uppermost hole of the first plurality of first holes and an uppermost end of a forwardmost groove of the plurality of first grooves, and wherein the distance between the second hole and the third hole is less than a second distance between a lowermost hole of the plurality of first holes and an lowermost end of a rearmost groove of the plurality of first grooves.

5. The apparatus of claim 1, wherein a length of each the plurality of first grooves is greater than a distance between an uppermost hole and lowermost hole of the plurality of first holes.

6. The apparatus of claim 1, wherein the at least one surface is a first surface configured proximate to the first side and a second surface configured proximate to a second side the second side of the backrest to support the backrest.

7. The apparatus of claim 1, wherein the plurality of first holes are configured vertically and the plurality of first grooves are vertical grooves configured in parallel.

8. The apparatus of claim 1, wherein the apparatus is a sauna.

9. A sauna comprising:
a seat configured horizontally;
a backrest comprising a first side, a second side, and a bottom side adjacent to the seat, wherein the backrest is configured at an angle to the seat and between a first mount adjacent to the first side and a second mount adjacent to the second side, wherein the first mount comprises a plurality of first holes configured vertically, the plurality of first holes configured above a plurality of first vertical grooves configured in parallel, and the second mount comprises a plurality of second holes configured vertically, the plurality of second holes configured above a plurality of second vertical grooves configured in parallel;
wherein the first side is configured to engage one of the plurality of first holes and the second side is configured to engage one of the plurality of second holes to set a height of the backrest, and
wherein the first side is configured to engage one of the plurality first vertical grooves and the second side is configured to engage one of the plurality of second vertical grooves to set the angle between the seat and the backrest.

10. The sauna of claim 9, wherein the first mount is a first wall of the sauna and wherein the second mount is a second wall of the sauna.

11. The sauna of claim 9, wherein a number of the plurality of first holes is equal to a number of the plurality of second holes, and wherein a number of the plurality of first vertical grooves is equal to a number of the plurality of second vertical grooves.

12. The sauna of claim 9, wherein the first side comprises a first hole proximate on an upper portion of the first side and the second side comprises a second hole proximate to an upper portion of the second side, the sauna further comprising:
a first dowel pin extending through the first hole in the first side to one of the plurality of first holes in the first mount; and
a second dowel pin extending through the second hole in the second side to one of the plurality of second holes in the second mount.

13. The sauna of claim 12, wherein the first side comprises a first hole proximate on a lower portion of the first side and the second side comprises a second hole proximate to a lower portion of the second side, the sauna further comprising:
a first dowel pin extending through the first hole in the first side to one of the plurality of first vertical grooves in the first mount; and
a second dowel pin extending through the second hole in the second side to one of the plurality of second vertical grooves in the second mount.

14. The sauna of claim 13, wherein the first dowel pin and the second dowel pin are wooden dowel pins.

15. The sauna of claim 9, wherein the first side is parallel to the first mount along a first surface, the second side is parallel to the second mount along a second surface, and the first side and second side are coupled together to form a curved third surface.

16. The sauna of claim 15, wherein the third surface is configured to engage a lower region of a spinal column of a user.

17. The sauna of claim 9, further comprising a plurality of wooden slats configured between the first side and the second side.

18. A sauna comprising:
a seat configured horizontally;
a backrest comprising a first side, a second side, and a bottom side adjacent to the seat, wherein the backrest is configured at an angle to the seat and supported by one or more adjustable mounting means for setting a height and angle configured on one or more walls of the sauna and adjacent to one or more of the first side and the second side; and
means for engaging the adjustable mounting means coupled between at least one of the first side and a first surface or the second side and a second surface.

19. The sauna of claim 18, wherein the adjustable mounting means comprises a plurality of holes set a height of the backrest and a plurality of grooves set an angle of the backrest.

20. The sauna of claim 19, wherein the means for engaging comprises a plurality of dowel pins for engaging the plurality of holes and the plurality of grooves.

21. The sauna of claim 18, wherein the seat, the backrest, the one or more walls, the adjustable mounting means, and the means for engaging are wood, the sauna further comprising a plurality of wooden slats configured between the first side and the second side.
